(19) United States
(12) Patent Application Publication
(10) Pub. No.: US 2006/0134584 A1
(43) Pub. Date: Jun. 22, 2006

(54) Chore tracker and method of use

(76) Inventor: Geron W. Holmes, East Yaphank, NY (US)

Correspondence Address: Galasso & Associates, LP, P. O. Box 26503, Austin, TX, 78755-0503, US

(21) Appl. No.: 11/269,097

(22) Filed: Nov. 8, 2005

Related U.S. Application Data
(60) Provisional application No. 60/638,043, filed on Dec. 21, 2004.

(51) Int. Cl. G09B 19/18

(52) U.S. Cl. 434/108

(57) ABSTRACT

The chore tracker is a device which provides an individual with a means of listing the chores, specifically those that need to be completed on a daily basis and then keeping track of whether the chore or task has been completed. The chore tracker comprises two columns, one indicating a chore needs to be completed and the other indicating the chore has been completed. When the sliding tab shows red the chore needs to be completed. Once the chore has been completed then the sliding tab is moved so that it shows green in the completed column. At a specified time, all of the sliding tabs are returned to the non-completed status. Therefore, each task would start fresh on a daily basis by showing the chore as needing to be completed.

### RELATED APPLICATIONS

This application claims priority to U.S. Provisional Patent Application Ser. No. 60/638,043 filed Dec. 21, 2004.

### FIELD OF THE DISCLOSURE

A message board that allows a user to list chores to be done and track whether the chores are competed or not.

### BACKGROUND

On a daily basis, everyone has a number of tasks or chores that need to be completed. For example, if you are a pet owner, then you need to make sure that the dog is feed daily. As the day kicks into high gear in most households, keeping up with the daily chores is not always as easy as it may seem. When more than one person lives in a house, it is even harder to not only keep track of the chores/tasks that need to be completed but to also know whether they were actually completed. For example, if one person gets up and leaves the house before the other one, then does the second person actually know whether the first person fed the dog? There are a number of chores like this that can simply be overlooked or left to chance. The greater the number of participants in a house, the greater the risk of certain chores not be completed. For example, if children are assigned chores to be completed after school, then by providing them a list it makes it easier for them to remember what they are supposed to do. There are also things that need to be completed at certain times. For example, if medication is to be administered, then making a list with the specified times makes tracking easier.

There are lots of items on the market that are helpful with tracking chores. Some are very simple, including just a note pad capable of being attached to the refrigerator. There are also all types of paper that come with lines for writing in chores. Some paper even has boxes next to the lines that allows you to check off when that chore has been completed. These types of paper are extremely helpful if you need to take the list with you. For example, if you are going shopping and have several places where you need to go then you can make a list and take the list with you. Once you have been to the place listed, you can check the box off indicating that task is completed.

White boards are another example of a way to list chores or tasks that need to be completed. This type of medium is used in an office atmosphere quite regularly. It allows the user to list the tasks to be completed and when completed to erase the task. Using a white board has proven to be very effective but it too has some drawbacks. For example, if you need the board for another purpose, then you must copy the tasks to paper posing the threat of them getting lost. Also, if you leave the list on the board for an extended period of time, then the ability to erase the list become more problematic. While you can erase the list, you end up with shading from the list permanently on the board.

Still another alternative for tracking tasks is described in U.S. Pat. No. 5,934,707 by Johnson. The message calendar described in this patent includes a calendar, a clock and a group of masks. The masks as well as removably adhered members bearing messages rendered in written languages are used to place on the various days where that particular task needs to be completed. For example, if your child has soccer practice on Tuesday, then you could place a note on Tuesday indicating soccer practice. This particular configuration only provides a means of writing on the specified adhering members. It also includes a clock and a place for storing the masks and adhering members. Unfortunately, when you have tasks that are repeated on a daily basis or multiple tasks this configuration is not extremely effective.

Chores/tasks are just part of everyone's daily life. Finding a system that works best for an individual has so many variables. What works for one person does not always work for another person.

### SUMMARY OF THE DISCLOSURE

In one embodiment of the chore tracker would comprise a rectangular writing board.

In another embodiment the chore tracker comprises a clean writing surface.

In still another embodiment the chore tracker comprises a metal frame.

In yet another embodiment the chore tracker includes metal clip for holding a note pad.

In another embodiment the chore tracker comprises a tray for holding writing utensils.

In still another embodiment the chore track comprises a set of slideable tabs.

In yet another embodiment the slideable tabs include one red end and one green end.

In another embodiment the chore tracker comprises a battery powered analog clock.

In still another embodiment the analog clock would be capable to moving the slideable tabs.

In yet another embodiment the writing surface would comprise a series of horizontal lines.

In another embodiment the red and green slideable tabs would be aligned in two columns.

In still another embodiment the two columns would be indicative of a completed task or a task to be completed.

In yet another embodiment the slideable tabs would be capable of being moved by hand.

In another embodiment the slideable tabs would be moved electronically at a given time.

In another embodiment the writing surface would be comprised of a dry-erase board.

In still another embodiment the writing surface would be comprises of a chalk board.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a perspective view of the Chore Tracker.

FIG. 2 is a detailed view of the done/not done section of the Chore Tracker depicted in FIG. 1.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

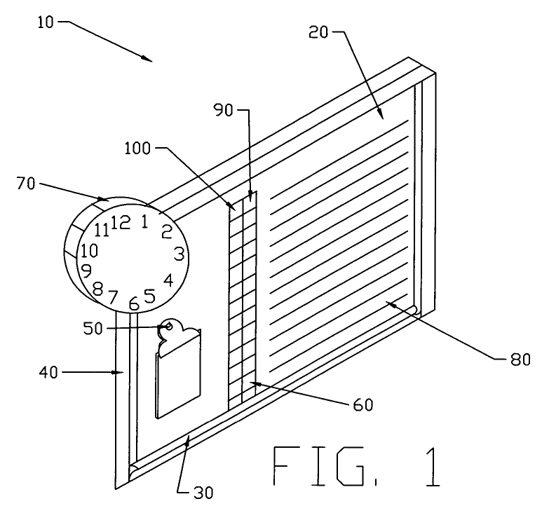

FIG. 1 is a perspective view of a chore tracker 10 comprising a rectangular writing board 20, a writing utensil tray 30, a metal frame 40, a metal clip 50, slideable tabs 60, a clock 70, horizontal lines 80, a to be completed task column 90 and a completed task column 100. The chore tracker 10 is designed to provide a way of keeping track of everyday chores and whether those chores are completed. The rectangular writing board 20 is enclosed within a metal frame 40 which is capable of being hung on a wall or similar type structure. Included as part of the metal frame 40 is a writing utensil tray 30 which is located on the lower portion of the rectangular writing board 20. The writing utensil tray 30, provides a place for pencils, pens, dry-erase markers or chalk, depending on the surface section of the rectangular writing board 20.

The horizontal lines 80 on the rectangular writing board 20 allow the user to list the chores that need to be performed. Additionally, the rectangular writing surface 20 has a metal clip 50 which allows a user to hang a clip board or other writing materials, which could easily removed. By attaching a writing material on the metal clip 50, it would provide a writing surface for such things as a shopping list. There are two columns also located on the rectangular writing surface 20. One of the columns is a to be completed task column 90 and the second column is a completed task column 100. The to be complete task column 90 and the completed task column 100 are located perpendicular to the horizontal lines 80. Therefore, beside each of the horizontal lines 80 is an indicator capable of pointing out whether a chore or task has been completed or not.

Also, located on the rectangular writing surface 20 and connected to the metal frame 40 is a clock 70. Not only does the clock 70 provide a convenient time measuring device for time sensitive chores, it also works to reset the slideable tabs 60 at a specified time. For example, the clock 70 can cause the slideable tabs 60 to be moved from the completed task column 100 to the to be completed task column 90 at midnight. Therefore, each day would begin with all of the slideable tabs 60 indicating that all of the chores need to be completed.

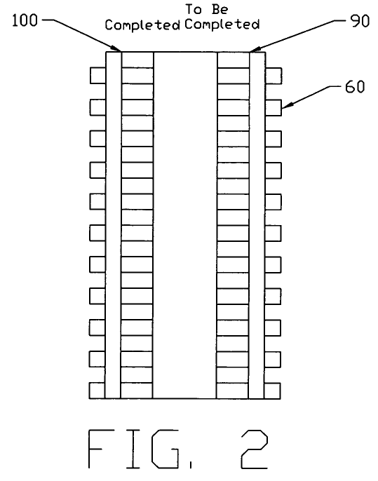

FIG. 2 is a detailed view of the slideable tabs 60 section of the rectangular writing surface 20. The slideable tabs 60 are designed to be moved from the to be completed task column 90 to the completed task column 100 when the chore is actually completed. By moving the slideable tabs 60 from one column to the other, a user can quickly determine what has be completed and what still needs to be completed. The slideable tabs 60 are designed with red and green designators. By sliding the slideable tabs 60 from one direction to the other, either the red or the green section is visible in the appropriate column. For example, a task or chore that still requires completion would have the slideable tabs 60 show red under the not done or to be completed task column 90. Once a chore is actually completed then the slideable tabs 60 should be moved to show the green section of the slideable tabs 60. By moving the slideable tabs 60 to delineate the green section of the slideable tabs 60 in the completed task column 100, you have indicated that the task has been completed. A user would continue to use this process until the entire list of chores has been completed. Once all of the chores are completed, the slideable tabs 60 can be returned to the original position showing the red section in the to be completed task column 90. However, should the user forget to physically move the slideable tabs 60 back, then the slideable tabs 60 would automatically be moved back at a specified time, i.e. midnight. This allows the user to start with a clean slate everyday. So if the dog needs to be fed, then every morning you can see that the dog has not been fed by looking at the chore tracker 10. By having the clock 70 specify the time the slideable tabs 60 are returned to indicate red in the to be completed task column 90, there is nothing left to chance. For example, you do not have to worry about whether the user remembered to reset the slideable tabs 60 or not. This prevents the chore tracker 10 from indicating a chore has been completed when in fact it has not been completed.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. A chore tracking device comprising;
a rectangular writing board further comprising:
an easy to clean writing surface;
a tray for holding writing utensils;
a metal frame; and
a metal clip for holding a note pad;
a set of slideable tabs wherein one end is red and the other end is green arranged in two columns; and
a battery powered analog clock wherein said clock is operable to move said set of tabs.

2. A chore tracking device of claim 1, wherein said writing surface comprises a series of horizontal lines for listing chores.

3. A chore tracking device of claim 1, wherein said red and green tabs are aligned in two columns, and wherein said columns are indicative of a task to be completed or a task completed.

4. A chore tracking device of claim 1, wherein said set of red and green tabs are operable to be moved by hand.

5. A chore tracking device of claim 1, wherein said set of red and green tabs are operable to be moved electronically at a given time.

6. A chore tracking device of claim 1, wherein said writing surface is a dry-erase board.

7. A chore tracking device of claim 1, wherein said writing surface is a chalk board.

8. A chore tracking system comprising:
a rectangular writing board further comprising:
an easy to clean writing surface;
a tray for holding writing utensils;
a frame encompassing said writing board ; and
a metal clip for holding a note pad;
a set of slideable tabes wherein one end is red and other end is green arranged in two columns, wherein said slideable tabs are operable to be moved by hand or electronically; and
a battery powered analog clock wherein said clock is operable to move said set of slideable tabs to indicate red at a given time.

9. A chore tracking system of claim 8, wherein said writing surface is a dry erase board.

10. A chore tracking system of claim 8, wherein said writing surface is a chalk board.

11. A chore tracking system of claim 8, wherein said red and green tabs are aligned in two columns, and wherein said columns are indicative of a task to be completed or a task completed.

12. A method of tracking chores comprising a writing surface, writing utensils, a clock, set of red and green tabs, two columns indicating a completed chore or a chore to be completed; said method comprising the steps of:
using said writing utensil to make a list of chores on the writing surface along side two columns indicated a completed chore or a chore to be completed;
completing a chore and moving said slideable tab to indicate green in the completed column;
continuing to complete chores until all of the slideable tabs indicate green in the completed column or until a specified time;
automatically moving the slideable tabs back to their original uncompleted or red position at a designated time.
